(19) United States
(12) Patent Application Publication
(10) Pub. No.: US 2026/0076500 A1
(43) Pub. Date: Mar. 19, 2026

(54) INTELLIGENT GROUNDING AND FEEDBACK SYSTEM FOR ENHANCING PERFORMANCE OF PRACTICE

(71) Applicant: Brainy Heads Inc., Roseville, CA (US)

(72) Inventor: Amr Higgy, Roseville, CA (US)

(21) Appl. No.: 19/333,198

(22) Filed: Sep. 18, 2025

Related U.S. Application Data
(60) Provisional application No. 63/696,097, filed on Sep. 18, 2024.
(60) Provisional application No. 63/720,081, filed on Nov. 13, 2024.

(51) Int. Cl. A47G 33/00; G06F 1/16

(52) U.S. Cl. CPC A47G 33/008; G06F 1/163; A47G 2200/10; A47G 2400/10

(57) ABSTRACT

Systems and methods for using an intelligent conductive floor mat and sensors to improve the performance of a practice is provided herein. The conductive floor mat may be electrically grounded. One or more sensors may be used to sense environmental data regarding the environment surrounding the conductive floor mat. One or more other sensors may be used to sense physiological data of a user that performs a practice. A computing device may use the sensors to evaluate the suitability of an environment around the conductive floor mat for performing the practice. The computing device may also identify changes in the physiological state of the user while the user performs the practice in the environment.

### CROSS-REFERENCE TO PRIOR APPLICATIONS

The present application claims priority to U.S. Provisional Application Numbers 63/696,097 filed on Sep. 18, 2024, and entitled CONDUCTIVE FLOOR AND/OR MAT SYSTEM FOR ENHANCING SPIRITUAL EXPERIENCE WITH INTEGRATED GROUNDING TECHNOLOGY AND A SMART SYSTEM, COMPANION APP AND/OR SMART WEARABLE FOR MONITORING PRAYER AND PHYSIOLOGICAL METRICS, and 63/720,081 filed on Nov. 13, 2024, and entitled SYSTEM AND METHOD FOR DETECTING, TRACKING AND OPTIMIZING PRAYER PERFORMANCE USING WEARABLE SENSORS AND ARTIFICIAL INTELLIGENCE, which are incorporated by reference herein. Where the present application and a document incorporated by reference conflict, the present application controls.

### BACKGROUND

### Technical Field

The present disclosure relates to conductive flooring and/or mat systems, such as those designed for enhancing spiritual experiences during prayer, meditation, and physical activities like exercise. The present disclosure further relates to intelligent grounding technology and an accompanying app and/or wearable device for monitoring prayer performance, postures, and physiological metrics.

### BRIEF SUMMARY

The embodiments described herein may include a conductive mat or floor that acts as a grounding device for a user performing a practice. In some embodiments, the conductive mat or floor includes a grounding rod or other grounding system. In some embodiments, the conductive mat or floor includes one or more symbolic or aesthetic elements, such as, for example, the pointed arch, calligraphy, colors, geometric patterns, etc. In some embodiments, the environment around the conductive floor mat is evaluated for suitability to performing the practice. In some embodiments, physiological data regarding a user is collected while the user performs the practice.

A system for improving practices performed by users may include a conductive floor mat, the conductive floor mat being electronically connected to a grounding rod or an existing grounding system. The system may also include one or more sensors configured to sense environmental data regarding the environment surrounding the conductive floor mat. The system may also include a computing device in communication with the one or more sensors, the computing device being configured to: receive environmental data from the one or more sensors; generate an evaluation of the environment around the conductive floor mat based on the environmental data; and indicate the evaluation of the environment via a display.

In some embodiments, the conductive floor mat includes one or more of: carbon fiber; copper; silver; conductive carbon leather; fibers; and natural rubber. In some embodiments, the one or more sensors may include one or more of: a magnetometer; an electromagnetic field sensor; a photonic sensor unit; and a grounding sensor. In some embodiments, the computing device is further configured to: apply a machine learning model to the environmental data to obtain the evaluation of the environment, the machine learning model being configured to generate an evaluation of an environment based on environmental data. In some embodiments, the one or more sensors may include a photonic sensor unit and at least one other sensor, where: the photonic sensor unit is caused to open a shutter of the photonic sensor unit for a selected period of time; and the at least one other sensor is caused to sense data regarding the environment surrounding the conductive floor mat while the shutter of the photonic sensor unit is open. In some embodiments, to receive the environmental data from the one or more sensors, the computing device is further caused to: cause at least one of the one or more sensors to obtain initial background condition data before the shutter of the photonic sensor unit is opened. In some embodiments, initial background condition data may include at least one of: electromagnetic field data; and geomagnetic field data. In some embodiments, conductive floor mat is a prayer mat having one or more sensors selectively positioned to detect a posture of an Islamic prayer. In some embodiments, the system comprises a wearable device configured to detect one or more of a prayer, prayer motions, a recitation, and a chant.

In some embodiments, one or more instances of non-transitory computer-readable media collectively having contents configured to cause a computing device to perform a method comprising: receiving an indication of a practice performed by a user; in response to receiving the indication of the practice performed by the user, receiving sensor data from one or more sensors, the sensor data indicating a physiological state of the user; receiving environmental data regarding the environment in which the practice is performed by the user; identifying one or more changes in the physiological state of the user as a result of performing the practice based on the sensor data; and determining whether the environment in which the practice is performed affected the physiological state of the user based on the one or more changes in the physiological state of the user, the environmental data, and historical data indicating the physiological state of the user when performing the practice.

In some embodiments, the one or more sensors include at least one of: a gyroscope; a microphone; an accelerometer; a heart rate sensor; a blood pressure sensor; global-positioning system (GPS); barometer; and a compass. In some embodiments, receiving the indication of a practice performed by the user further may include: receiving second sensor data from the one or more sensors; and determining whether the user has begun performing the practice based on the sensor data. In some embodiments, determining whether the user has begun performing the practice further may include: applying a machine learning model to the second sensor data, the machine learning model being configured to identify one or more positions of the user based on sensor data; and determining whether the user has begun performing the practice based on the one or more positions. In some embodiments, the method further may include: applying a machine learning model to the sensor data, the machine learning model being configured to identify one or more positions of the user based on sensor data; receiving an indication of one or more positions of a user when performing the practice; determining whether the user performed at least one aspect of the practice incorrectly based on the identified one or more positions and the indication of one or more positions of a user when performing the practice; and based on a determination that the user performed at least one aspect of the practice incorrectly, indicating that the user performed at least one aspect of the practice incorrectly. In some embodiments, receiving the environmental data further may include: receiving environmental data from one or more environmental sensors of a conductive floor mat, the one or more environmental sensors being configured to sense environmental data regarding the environment surrounding the conductive floor mat.

A system for improving a practice performed by a user may include a conductive floor mat, the conductive floor mat being electronically connected to a grounding rod. The system may also include a first set of sensors configured to sense environmental data regarding the environment surrounding the conductive floor mat. The system may also include a second set of sensors configured to sense physiological data of a user. The system may also include at least one computing device in communication with the first set of sensors, the at least one computing device being configured to: receive environmental data from the one or more sensors; generate an evaluation of the environment around the conductive floor mat based on the environmental data; indicate the evaluation of the environment via a display; receive an indication of a practice performed by a user; in response to receiving the indication of the practice performed by the user, receiving physiological data from the second set of sensors; identifying one or more changes in the physiological state of the user as a result of performing the practice based on the physiological data; determine whether the environment in which the practice is performed affected the physiological state of the user based on the one or more changes in the physiological state of the user, the environmental data, and historical data indicating the physiological state of the user when performing the practice; and indicate to the user whether the environment in which the practice is performed affected the physiological state of the user.

In some embodiments, the first set of sensors may include one or more of: a magnetometer; an electromagnetic field sensor; and a photonic sensor unit. In some embodiments, the second set of sensors may include one or more of: a gyroscope; a microphone; an accelerometer; a heart rate sensor; a blood pressure sensor; and a compass. In some embodiments, at least one sensor of the second set of sensors is a wearable sensor.

### BRIEF DESCRIPTION OF THE SEVERAL VIEWS OF THE DRAWINGS

FIG. 1 is a block diagram of a sample practice improvement system, according to various embodiments described herein.

FIG. 1A is a block diagram of an environment in which a practice improvement system may operate, according to various embodiments described herein.

FIG. 2A is a diagram of a sample conductive floor mat, used by the practice improvement system in various embodiments described herein.

FIG. 2B is a diagram of an environment in which a conductive floor mat is placed, according to various embodiments described herein.

FIG. 3 is a flow diagram of a sample process for evaluating an environment in which a conductive floor mat is placed, according to various embodiments described herein.

FIG. 4 is a flow diagram of a sample process for evaluating a physiological state of a user of a conductive floor mat during performance of a practice, according to various embodiments described herein.

FIG. 5 is a flow diagram of a sample process for determining whether a user incorrectly performed an aspect of a practice, according to various embodiments described herein.

FIG. 6 display diagram of sample screens presented via a display after a user's performance of a practice, according to various embodiments described herein.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures and components associated with battery management devices or systems or utilizing battery management devices or systems have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

The use of ordinals such as first, second, third, fourth, etc., does not necessarily imply a ranked sense of order, but rather may only distinguish between multiple instances of an act or structure.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms “top,” “upper,” “lower,” “left,” and “right,” are used for only discussion purposes based on the orientation of the components in the discussion of the figures in the present disclosure as follows. These terms are not limiting as to the possible positions explicitly disclosed, implicitly disclosed, or inherently disclosed in the present disclosure.

The term “substantially” is used to clarify that there may be slight differences or variations as for when a surface is coplanar with another surface in the real world, as nothing can be made perfectly equal or perfectly the same. In other words, substantially means that there may be some slight variation in actual practice, and instead, is made within accepted tolerances.

As used in this specification and the appended claims, the singular forms “a,” “an,”and “the”include plural referents unless the content clearly dictates otherwise.

Spiritual practices such as prayer, meditation, and yoga are essential components of many cultures and religions worldwide. These practices are often undertaken to promote mental clarity, emotional well-being, and spiritual connection, and provide benefits to practitioners of the practice, such as improved mental health, stress reduction, emotional regulation, and overall well-being. Despite the broad recognition of these benefits, many people struggle to maintain focus, achieve a state of relaxation, or fully immerse themselves in their spiritual practices due to the distractions and stresses of modern life. As a result, there is an increasing demand for solutions that can detect, track and deepen the spiritual experience while also enhancing physical and mental well-being.

As technology continues to advance, there is an increasing trend towards integrating wearables and mobile applications with spiritual and wellness practices. Smartwatches, fitness trackers, and meditation apps have gained popularity for their ability to monitor physical health metrics and provide feedback on activities such as exercise, sleep, and mindfulness practices. However, despite the growing use of wearables and apps for wellness, conventional devices do not provide this feedback for users during prayer or meditation.

Some conventional devices track general physiological metrics such as heart rate or breathing patterns, but do not offer specific guidance on proper alignment or posture during spiritual practices like prayer. For instance, users engaged in Islamic prayer perform a series of movements and postures with precision. Without real-time feedback, users may unknowingly make mistakes in their postures, potentially detracting from the physiological, and physical benefits of the practice. Furthermore, existing technologies do not incorporate feedback on the quality of the environment around the user while performing their practice, which can effect the relaxation, focus, and overall experience, of the user while performing the practice.

The embodiments described herein address these disadvantages of conventional devices by utilizing modern sensors and applications to enhance the user's performance of a practice. The embodiments described herein also promote relaxation, stress reduction, and cardiovascular and other health improvements (such as through increased heart rate variability (“HRV”)).

The embodiments described herein may use techniques related to “grounding.” Grounding refers to the practice of physically connecting to the Earth's natural energy by placing the body in direct contact with conductive surfaces like the ground. Scientific research suggests that grounding may reduce inflammation, improve sleep, and enhance cardiovascular function by stabilizing the body's bioelectrical environment. Grounding has been shown to have positive effects on heart rate variability (HRV), a marker of emotional regulation and cardiovascular health. By using grounding techniques, the embodiments describe therein may enhance focus and relaxation during spiritual activities.

Conventional grounding devices, such as grounding mats or beds, are primarily focused on improving sleep and reducing inflammation, rather than enhancing spiritual practices of a user. Conventional grounding devices also do not integrate symbolic or aesthetic elements designed to foster a deeper spiritual connection, which can play an important role in enhancing spiritual focus and mindfulness. For example, Islamic prayer spaces often incorporate geometric patterns, calligraphy, and architectural elements, such as the pointed arch, to create an environment that fosters contemplation and reverence.

Scientific studies have demonstrated that exposure to aesthetically pleasing visual stimuli, such as geometric patterns, can reduce stress and promote a sense of calm. For instance, symmetric and repetitive patterns are associated with inducing relaxation and focus, both of which are essential for an effective prayer or meditation session. Islamic calligraphy, revered for its beauty and intricacy, also evokes emotional and spiritual responses, aiding in concentration and mindfulness. Although these effects have been widely recognized anecdotally and culturally, there is still a gap in products that specifically use symbolic and visual elements to enhance spiritual practices in combination with modern technology.

The embodiments described herein may include a conductive mat or floor that acts as a grounding device for a user performing a practice. In some embodiments, the conductive mat or floor includes a grounding rod. In some embodiments, the conductive mat or floor includes one or more symbolic or aesthetic elements, such as, for example, the pointed arch, calligraphy, etc.

Some of the embodiments described herein integrate grounding technology, symbolic visual elements, and real-time physiological monitoring, to provide users with a comprehensive solution that enhances both the physiological and physical dimensions of prayer, meditation, and other spiritual practices. In some embodiments, a conductive floor or mat includes one or more sensors for sensing environmental data that can be used to evaluate an environment's suitability for performing a practice. In some embodiments, an application or device provides feedback to a user regarding their physiological state before, during, and after performing a practice. In some embodiments, the application or device provides feedback regarding the user's focus, posture, etc., during performance of a practice. In some embodiments, an application or device provides feedback to a user regarding the location of a mat used to perform the practice.

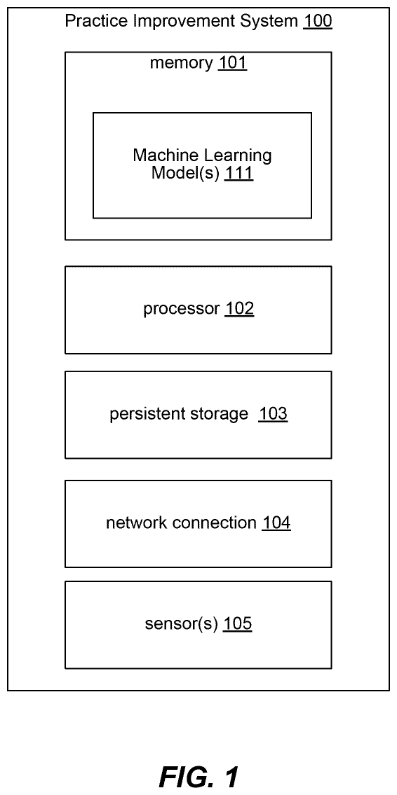

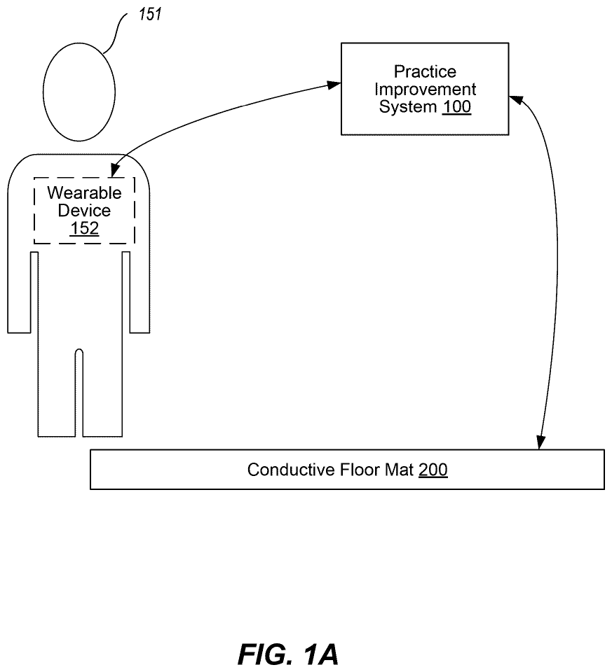

FIG. 1 is a block diagram of a sample computer device that implements a practice improvement system 101, according to various embodiments described herein. In various embodiments, the computer system(s) and other device(s) that implement the practice improvement system 101 can include server computer systems, cloud computing platforms or virtual machines in other configurations, desktop computer systems, laptop computer systems, netbooks, mobile phones, personal digital assistants, televisions, cameras, automobile computers, electronic media players, wearable devices, etc. In various embodiments, the computer systems and devices include zero or more of each of the following: a processor 102 for executing computer programs and/or training or applying machine learning models, such as a CPU, GPU, TPU, NNP, FPGA, or ASIC; a computer memory 101 for storing programs and data while they are being used, including the facility and associated data, an operating system including a kernel, and device drivers; a persistent storage device 103, such as a hard drive or flash drive for persistently storing programs and data; a network connection 104 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like; and one or more sensors 105 for obtaining data regarding an environment, the physiological state of a user, or the motion of a user, such as a heart rate sensor, a blood pressure sensor, a gyroscope, an accelerometer, a compass, a magnetometer, a photonic sensor, an electromagnetic field sensor, oxygen sensors, global-positioning system (GPS) sensors, pressure sensors, barometric sensors, ambient light sensors, capacitive sensors, conductivity sensors, an EEG sensor, an EKG sensor, a PPG sensor, a galvanic skin response sensor, a bioimpedance sensor, a thermometer, an EMG sensor, an inertial measurement unit, a LiDAR sensor, an ultrasonic sensor, a Geiger counter, a capacitive sensor, a conductivity sensor, a resistivity sensor, an ambient light sensor, a humidity sensor, a barometric pressure sensor, other sensors, or a combination thereof. None of the components shown in FIG. 1 and discussed above constitutes a data signal per se. While computer systems configured as described above are typically used to support the operation of the facility, those skilled in the art will appreciate that the facility may be implemented using devices of various types and configurations, and having various components. In some embodiments, at least a portion of the one or more sensors are included in a wearable device, a conductive floor mat, a user device (i.e. a smartphone), one or more other devices, or some combination thereof.

The memory 101 may store an indication of one or more artificial intelligence or machine learning models 111. In some embodiments, the machine learning models 111 include a posture model trained to identify a posture or position of a user performing a practice. In some embodiments, the posture model is a type of classifier machine learning model, such as a rule-based threshold model, a random forest model, a recurrent neural network model, a long short-term memory model, etc. The posture model may be trained by using motion data, physiological data, or a combination thereof, from a plurality of users performing a specified practice. For example, to train the posture model to identify positions performed by users during Islamic prayer, training data is obtained from users performing Islamic prayer. In some embodiments, the training data includes motion data, physiological data, or a combination thereof, obtained from one or more sensors near or on the users performing the practice, such as sensors included in a wearable device, sensors included in a user device (e.g. a smartphone), sensors included in other devices, or some combination thereof. For example, the motion data or physiological data may be obtained from wearable sensors that users wear, such as an accelerometer, a gyroscope, an oxygen sensor, a heart rate monitor, a compass, a microphone, etc.; from sensors in a mat, such as a conductive floor mat, upon which the practice is performed, such as pressure sensors, light sensors, a compass, a microphone, etc.; from other sources of motion data or physiological data of users performing a practice; or some combination thereof. In some embodiments, the motion data or physiological data includes the time at which data points were collected.

The training data is labeled based on the posture corresponding to the practice. In some embodiments, the training data is labeled based on time segments during which the postures would be performed by users performing the practice. In some embodiments, the training data is labeled by identifying one or more time segments in which a change in the physiological state of multiple users occurs. For example, during Islamic prayer, multiple users may perform the practice at the same time, would take the same positions at the same—or nearly the same—time, and perform each aspect of the practice in the same order. In such an example, it is possible to automatically identify and label time segments in the training data as being time segments in which users entered certain positions during the practice by identifying time periods where there is a change in the physiological data for multiple users.

The training data may be labeled based on one or more static positions and one or more transitional positions. Static positions are positions in which the user is still for a pre-selected period of time. Transitional positions are positions in which the user is transitioning from one position to another. For example, in Islamic prayer requires a user to perform static positions, such as standing, bowing, prostrating, and sitting positions for different amounts of time and in a set order. Transitional positions in Islamic prayer include transitioning from standing to bowing, from bowing to standing, standing to prostrating, prostrating to sitting, sitting to prostrating, sitting to standing, etc. In some embodiments, the positions may be further labeled based on the amount of time spent in each position during performance of the practice, the order in which the positions are taken during performance of the practice, etc. For example, in Islamic prayer, the first standing position may be performed for a longer period of time than the second standing position, which is taken after transitioning from a bowing position. In such an example, the first standing position may be labeled as “standing,” while the second standing position may be labeled as “short standing”.

In some embodiments, where the posture model uses audio data to identify a posture or position of a user performing a practice, the training data may include audio data. In such embodiments, the audio data may be labeled as corresponding to positions or postures associated with the practice, in a similar manner as described above. In some embodiments, the posture model or another machine learning model is trained to identify whether the user correctly verbalized a prayer, chant, recitation, etc., during their performance of the practice. In such embodiments, audio data is used as training data to train the machine learning model to identify whether the user has correctly verbalized a prayer, chant, recitation, etc., during their performance of the practice.

The training data is used to train the posture model to identify a position related to the practice of a user. In some embodiments, the posture model outputs one or more scores, or probabilities, that the user has taken one or more positions during the performance of a practice. In some embodiments, the trained posture model is formatted for integration with an application, such as an application that can be operated by a smartphone or wearable device.

In some embodiments, the machine learning models 111 include an environment evaluation model trained to output a score indicating the suitability of the environment in which the user is to perform the practice. In some embodiments, the environment evaluation model is a type of classifier machine learning model, such as a rule-based threshold model, a random forest model, a recurrent neural network model, a long short-term memory model, etc. The environment evaluation model may be trained based on environmental data received from one or more environments. The training data for the environment evaluation model may include data from one or more sensors placed in one or more environments, such as a gyroscope, an accelerometer, a compass, a magnetometer, a photonic sensor, an electromagnetic field sensor, GPS sensors, pressure sensors, barometric sensors, ambient light sensors, capacitive sensors, conductivity sensors, other sensors, or a combination thereof. The training data may be labeled based on how beneficial the environment is to performing a practice. In some embodiments, at least a portion of the training data is obtained from environments which are known to be beneficial or detrimental to performing a practice. In some embodiments, the training data includes a suitability score for each of the environments indicated by the training data. For example, training data received from locations such as natural settings, historically significant spiritual sites, etc., may be labeled as data describing “optimal locations.” As another example, training data received from locations near electrical panels, under power lines, etc., may be labeled as data describing “disturbed locations.” In some embodiments, the labels include a score representing the suitability of the location for performing the practice.

The training data is used to train the environment evaluation model to output an evaluation of an environment for performing a practice. In some embodiments, the posture model outputs one or more scores, or probabilities, indicating the suitability of the environment for performing the practice. In some embodiments, the trained environment evaluation model is formatted for integration with an application, such as an application that can be operated by a smartphone or wearable device.

FIG. 1A is a block diagram of an environment in which a practice improvement system may operate, according to various embodiments described herein. The environment includes a user, a practice improvement system 100, and a conductive floor mat 200. In some embodiments, the environment includes a wearable device 152. In some embodiments, one or more aspects of the practice improvement system 100 is incorporated into the conductive floor mat 200, the wearable device 152, a user device of the user 151, another device, or some combination thereof. The conductive floor mat 200, wearable device 152, and other devices, may communicate with the practice improvement system 100.

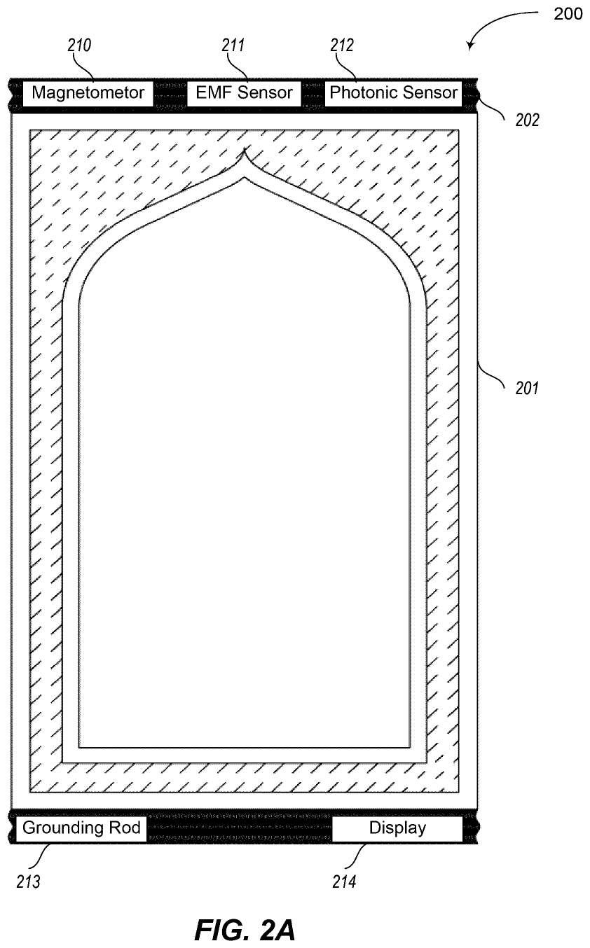

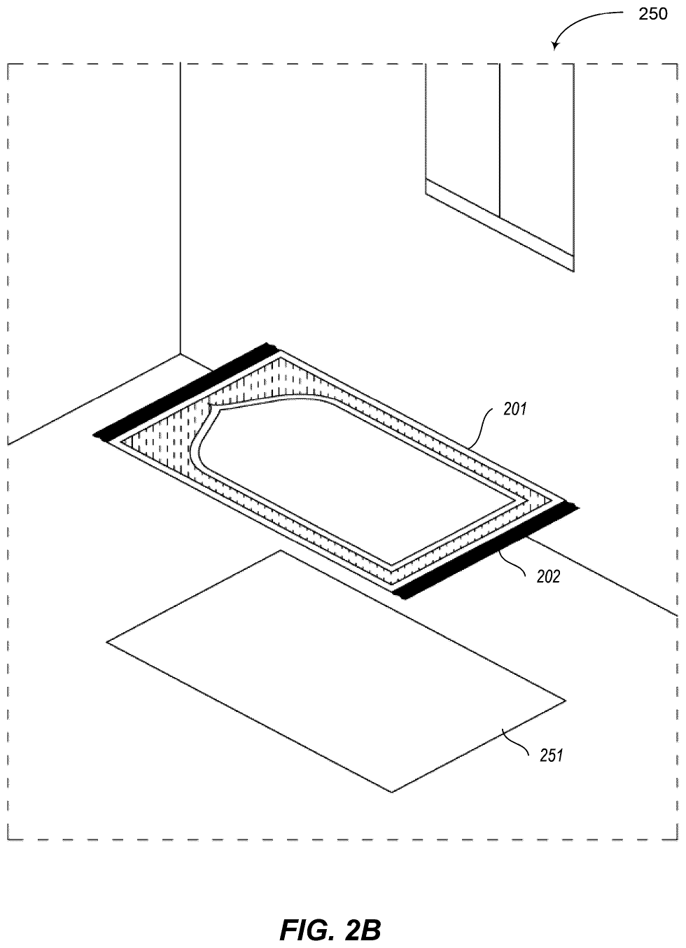

FIG. 2A is a diagram of a sample conductive floor mat 200, used by the practice improvement system in various embodiments described herein. The conductive floor mat 200 includes a practice floor mat 201 and a conductive surface 202. The practice floor mat 201 may be a floor mat used by a user to perform a practice. The practice floor mate 201 may be placed on top of, or in contact with, the conductive surface 202. The conductive surface 202 may be a surface placed on the ground or floor, and may be placed in contact with a practice floor mat 201. The conductive surface 202 may comprise one or more conductive materials, such as carbon fiber, copper, silver, or other conductive materials. In some embodiments, the conductive floor mat 200 includes one or more computing devices, such as a microcontroller or other computing device, that performs one or more of the operations described in connection with the embodiments described herein.

The conductive surface 202 may include one or more magnetometers 210, electromagnetic field (“EMF”) sensors 211, photonic sensors 212, grounding rods 213, and a display 214. Although FIG. 2A depicts the sensors, grounding rod, and display in particular positions on the conductive surface 202, embodiments are not so limited, and each of the components of the conductive surface 202 may be incorporated in different positions of the conductive surface 202. In some embodiments, the conductive surface 202 includes additional or fewer components. For example, in some embodiments, the conductive floor mat 200 does not include a display 214, a grounding rod 213, one or more of the sensors, etc. In some embodiments, the conductive floor mat 200 includes one or more sensors for detecting a user, such as a pressure sensor, heat sensor, etc. In such embodiments, data sensed by the sensors for detecting a user may be used to identify whether a user is using the mat, the user's posture while using the mat, or other aspects of the user's use of the mat when performing a practice.

A magnetometer, such as the magnetometer 210, is a sensor that measures the intensity and fluctuations of the local geomagnetic field (in microteslas, μT). The output of the magnetometer 210 can be used to identify natural anomalies (e.g., from underground water, mineral deposits) and unnatural disturbances. An EMF sensor 211 senses low-frequency alternating current fields (e.g. electromagnetic fields from wiring), high-frequency radiation (e.g. from wireless devices) in volts per meter. The output of the EMF sensor 211 may be used to identify anthropogenic pollution. A photonic sensor unit 212 includes a single-photon avalanche diode array housed within a light-tight, thermally-stabilized, enclosure with a mechanical shutter. The output of the photonic sensor unit 212 may be used to identify ultra-weak photon emission from surfaces and the local environment. In some embodiments, the photonic sensor unit 212 includes one or more interference filters for spectral analysis of ultra-weak photon emission.

The grounding rod 213 is a conductive rod or material that acts as an electrical ground. In some embodiments, the conductive surface 202 includes material that acts as an electrical ground. In such embodiments, the grounding rod 213 may or may not be included in the conductive floor mat 200. For example, the grounding rod may be or included in the conductive floor mat 200. As another example, the conductive floor mat 200 may include one or more materials that perform the same functions as the grounding rod. In such an example, a grounding rod 213 may or may not be included in the conductive floor mat 200. In some embodiments, the conductive floor mat 200 is connected to a grounding system other than a grounding rod, in addition to, or in place of, the grounding rod 213.

In some embodiments, the conductive floor mat includes a conductivity sensor. In such embodiments, the conductivity sensor is a sensor configured to detect whether the conductive floor mat 200 is grounded, such as by laying the floor mat 200 on the earth or connecting it to a grounding system or grounding rod.

The display 214 may be a screen, such as a liquid crystal display screen, light-emitting diode screen, or other type of screen that can display information; a collection of lights, such as LED lights; any other type of display that can display information to a user; or some combination thereof. In some embodiments, the conductive floor mat 200 does not include a display 214.

In some embodiments, the floor mat 201 and conductive surface 202 are integrated together, such that the floor mat 201 includes the sensors and materials that would be included in the conductive surface 202. In some embodiments, the floor mat 201 and conductive surface 202 are separate, such that the floor mat 201 may be placed into contact, such as on top of or next to, with the conductive surface 202, and may be removed from contact with the conductive surface 202.

In some embodiments, aspects of the conductive floor mat 200, such as the floor mat 201 and conductive surface 202, include one or more symbolic or aesthetic elements, such as pointed arch, geometric patterns, calligraphy, etc. In some embodiments, the aspects of the conductive floor mat 200 are colored using shades of green, shades of blue, earth tones, gold, silver, and white.

In some embodiments, the conductive floor mat 200 includes a plurality of layers. In such embodiments, the plurality of layers may be or include conductive polyurethane leather, fiber, rubber, polymers, synthetic materials, or other materials.

FIG. 2B is a diagram of an example environment 250 in which a conductive floor mat 200 is placed, according to various embodiments described herein. In the environment 250, the conductive surface 202 is placed in the environment at position 251. In this example, the floor mat 201 is placed on top of the conductive surface 202.

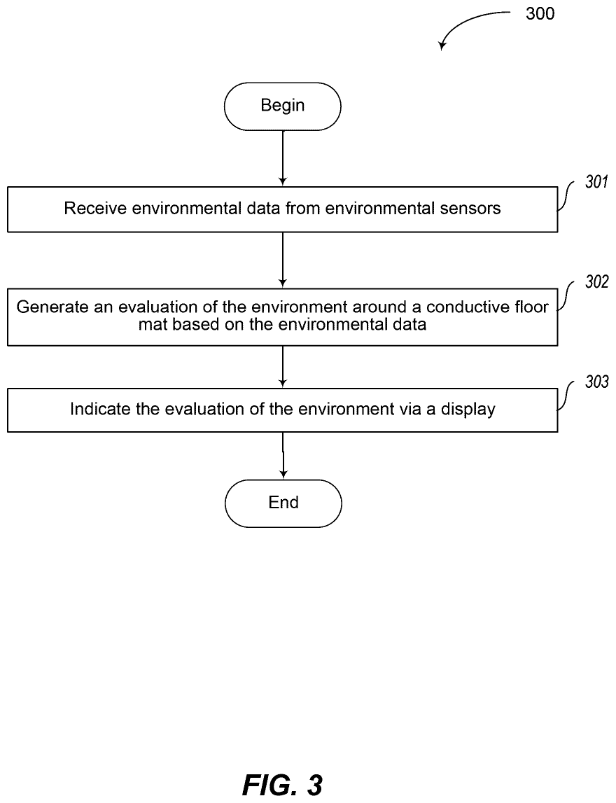

FIG. 3 is a flow diagram of a sample process 300 for evaluating an environment in which a conductive floor mat is placed, according to various embodiments described herein. One or more aspects of the process 300 may be performed by a conductive floor mat 200, a practice improvement system 100, other computing devices, or some combination thereof.

The process 300 begins, after a start block, at act 301, where environmental data is received from one or more environmental sensors. In some embodiments, at least a portion of the environmental sensors are sensors included in a conductive floor mat, such as a magnetometer, EMF sensor, photonic sensor, or other sensors that may be included in the conductive floor mat or used for sensing data regarding an environment. In some embodiments, at least a portion of the environmental data is received from sensors included in the practice improvement system 100, such as a gyroscope, a microphone, a camera, an accelerometer, or other sensors that may be included in the practice improvement system 100.

The process 300 proceeds to act 302, where an evaluation of the environment around the conductive floor mat is generated based on the environmental data. In some embodiments, the evaluation of the environment around the conductive floor mat includes an indication of whether the environment is suitable for performing the practice, is acceptable for performing the practice, or is not suitable for performing the practice. In some embodiments, an environment may be suitable for performing the practice if electromagnetic fields from wired and wireless sources does not exceed a threshold amount of volts per meter, if the intensity and fluctuations in the geomagnetic field does not exceed a threshold amount of microteslas, if the ultra-weak photon emission from surfaces and the local environment does not exceed a threshold amount, or a combination thereof. In some embodiments, the environment is not suitable for performing the practice if electromagnetic fields from wired and wireless sources exceeds a threshold amount of volts per meter, if the intensity and fluctuations in the geomagnetic field exceeds a threshold amount of microteslas, if the ultra-weak photon emission from surfaces and the local environment does not exceeds amount, or some combination thereof. In some embodiments, an environment may be acceptable for performing the practice if electromagnetic fields from wired and wireless sources exceed a first threshold amount of volts per meter but do not exceed a second threshold amount of volts per meter, if the intensity and fluctuations in the geomagnetic field exceeds a first threshold amount of microteslas but does not exceed a second threshold amount of microteslas, if the ultra-weak photon emission from surfaces and the local environment exceeds a first threshold amount but does not exceed a second threshold amount, or a combination thereof.

In some embodiments, an environment evaluation machine learning model is applied to the environmental data to obtain one or more scores indicating the suitability of the environment to performing the practice. In such embodiments, one or more scores may indicate whether the environment is suitable for performing the practice, acceptable for performing the practice, or is not suitable for performing the practice.

In some embodiments, to evaluate the environment in which the conductive floor mat is placed, initial baseline data is obtained for the space within which the conductive floor mat is located. In such embodiments, initial baseline sensor data may be received from an EMF sensor, a Magnetometer, or a combination thereof. In some embodiments, when the conductive floor mat is placed upon a spot within the space, additional sensor data is obtained to evaluate the suitability of the spot for performing the practice. In such embodiments, the photonic sensor may be caused to open its shutter for a selected period of time to obtain sensor data. In some embodiments, the EMF sensor and Magnetometer are configured to continually obtain sensor data. The initial baseline data and sensor data received from the spot within the space may be used to evaluate the environment around the conductive floor mat, such as by determining whether the spot within the space is suitable for performing the practice.

The process 300 proceeds to act 303, where the evaluation of the environment is indicated via a display. In some embodiments, the display is a display of a computing device that implements the practice improvement system 100, such as, for example, a display of a smartphone, a display of a wearable device, etc. In some embodiments, the display is a display of a conductive floor mat, such as the conductive floor mat 200 described above in connection with FIG. 2. For example, the display may indicate that the environment around the conductive floor mat is suitable or “optimal” for performing the practice by activating a green light. As another example, the display may indicate that the environment around the conductive floor mat is acceptable for performing the practice, but not “optimal,” by activating a yellow light. As yet another example, the display may indicate that the environment around the conductive floor mat is not suitable, or “disturbed,” for performing the practice by activating a red light. In some embodiments, the indication of the evaluation of the environment includes an indication of whether the user should move the conductive floor mat to a different spot before performing their practice.

After act 303, the process 300 ends.

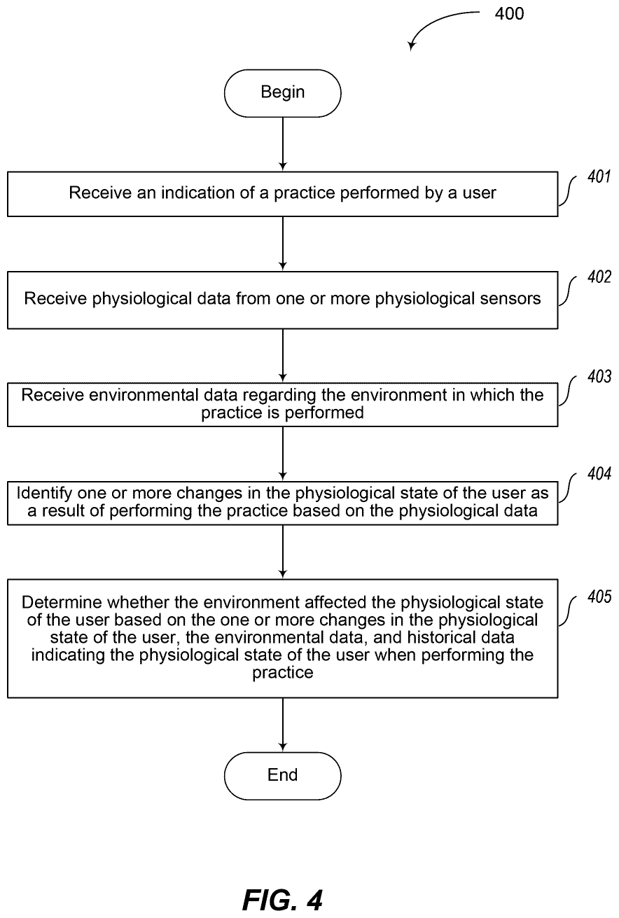

FIG. 4 is a flow diagram of a sample process 400 for evaluating a physiological state of a user of a conductive floor mat during performance of a practice, according to various embodiments described herein. One or more aspects of the process 400 may be performed by a conductive floor mat 200, a practice improvement system 100, other computing devices, or some combination thereof.

The process 400 begins, after a start block, at act 401, where an indication of a practice performed by a user is received. In some embodiments, the indication of the practice is received via user input. In some embodiments, the indication of the practice is received based on sensor data indicating that the user has begun performing the practice. For example, physiological data from sensors may indicate that the user has stepped onto the mat and taken one or more positions associated with performing the practice. These positions may include one or more of the following: standing upright, folding hands, positioning the folded hands in certain positions, raising or lowering hands, bowing by bending forward and placing hands on knees, prostrating by placing forehead, nose, palms, knees and toes on the ground, including on the prayer mat, sitting upright by placing hands on knees and knees and feet on the ground, and any other position associated with the Islamic prayer. In some embodiments, the practice may include reciting certain prayers or chants during one or more of the positions. The process may include one or more sensors to record and track such prayers or chants. In some embodiments, the one or more positions may be identified by applying a posture model, such as the posture model described above in connection with FIG. 1, to the physiological data to identify one or more positions taken by the user. In some embodiments, it is determined whether the user is performing, or about to perform, the practice based on sensor data, one or more time periods in which the user typically performs the practice, one or more time periods in which the user is scheduled to perform the practice, a direction that the user is facing, or some combination thereof. For example, Islamic prayer is typically performed at certain times of day and while facing a particular direction. In such an example, the time of day, direction faced by the user, and posture of the user may indicate that the user has begun performing the prayer practice.

In some embodiments, in response to receiving the indication that the user is to perform a practice, instructions regarding the performance of the practice are presented to the user, such as via a display of a conductive floor mat, user computing device, wearable computing device, other type of display, or some combination thereof.

The process 400 proceeds to act 402, where physiological data is received from one or more physiological sensors. In some embodiments, the physiological sensors are sensors included in a conductive floor mat, a user computing device, a wearable computing device, or some combination thereof. In some embodiments, the one or more physiological sensors include a heart rate monitor, blood pressure sensor, respiratory rate sensor, oxygen sensor, accelerometer, gyroscope, microphone, pressure sensor, other types of sensors, or a combination thereof. In some embodiments, the physiological data includes physiological data before the user began performing the practice and after the user began performing the practice. In some embodiments, the physiological data may indicate one or more of the postures or positions of the user while in, for example, Islamic prayer, as described above. By way of example, the one or more postures or positions may include whether and where the hands were placed, the bending of the knees, recitation of chants, etc. As another example, one or more of the postures or positions may be related to one or more prayers or chants recited by the user while taking the posture or position.

The process proceeds to act 403, where environmental data regarding the environment in which the practice is performed is received. In some embodiments, the environmental data is received from one or more sensors included in a conductive floor mat, user computing device, wearable computing device, or some combination thereof. In some embodiments, act 403 is performed in a similar manner to act 301.

The process proceeds to act 404, where one or more changes in the physiological state of the user as a result of performing the practice are identified based on the physiological data received from the physiological sensors. In some embodiments, the times at which changes in the physiological state of the user are detected are associated with aspects of performing the practice, such as positions that the user took while performing the practice. In some embodiments, a change in the user's physiological state is identified based on changes in the physiological data received from the sensors, such as changes in heart rate, breathing rate, oxygen saturation, pressure exerted by the user on the mat, temperature, etc. In some embodiments, the changes in the user's physiological state are indicated to the user. For example, a display of a user device may indicate what the user's physiological state was before performing the practice, during performance of the practice, and after the performance of the practice. In another example, the display of the user device may indicate how the user's physiological state changed during performance of the practice, and at which aspects of the practice the change occurred. In some embodiments, the physiological state of the user is represented by using the heart rate variability of the user, a measure of the stress experienced by the user, breathing patterns, etc.

The process proceeds to act 405, where it is determined whether the environment affected the physiological state of the user based on the one or more changes in the physiological state of the user, the environmental data, and historical data indicating the physiological state of the user when performing the practice. In some embodiments, the historical data includes data indicating the physiological state of users other than the user when performing the practice. In some embodiments, the historical data includes one or more averages for one or more physiological markers, such as heart rate, respiratory rage, oxygen saturation, stress, temperature, other physiological markers, or some combination thereof. In some embodiments, the historical data includes physiological data regarding the physiological state of the user when performing the practice in the past.

In some embodiments, determining whether the environment affected the physiological state of the user includes comparing historical data regarding the physiological state of the user when performing the practice with the data indicating the changes in the physiological state of the user. In such embodiments, when the environment is determined to not be suitable for performance of the practice, it may be determined that the environment affected the physiological state of the user.

### After Act 405, the Process 400 Ends.

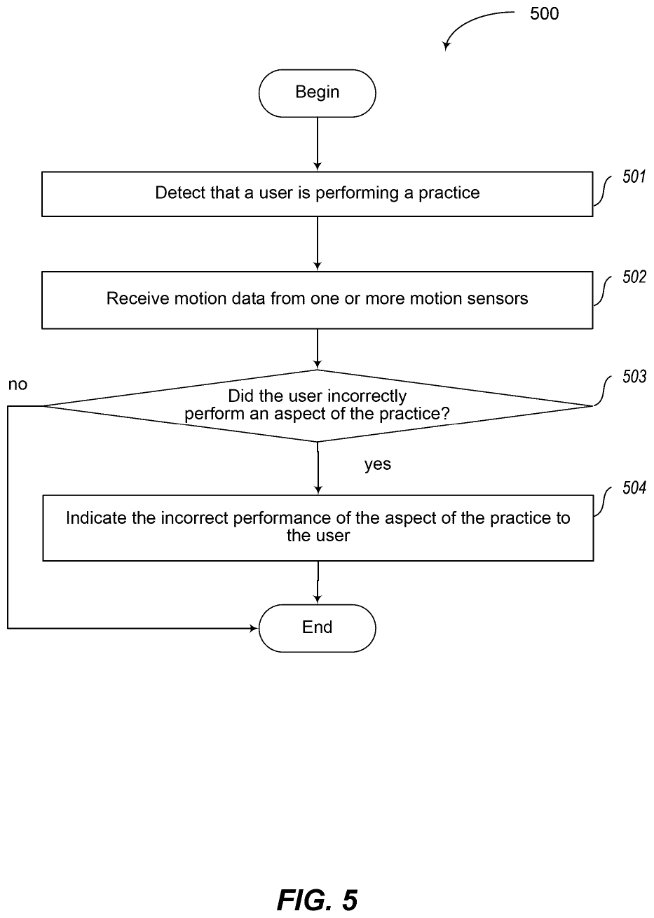

FIG. 5 is a flow diagram of a sample process 500 for determining whether a user incorrectly performed an aspect of a practice, according to various embodiments described herein. One or more aspects of the process 500 may be performed by a conductive floor mat 200, a practice improvement system 100, other computing devices, or some combination thereof.

The process 500 begins, after a start block, at act 501, where a user's performance of a practice is detected. In some embodiments, act 501 is performed in a similar manner to act 401.

The process 500 proceeds to act 502, where motion data is received from one or more motion sensors. In some embodiments, act 502 is performed in a similar manner to act 402.

The process 500 proceeds to act 503, where it is determined whether the user incorrectly performed an aspect of the practice. In some embodiments, determining whether the user incorrectly performed an aspect of the practice includes receiving an indication of one or more postures, poses, etc., taken by the user during the performance of the practice. In such embodiments, the indication of one or more postures, poses, etc., taken by the user during the performance of the practice is obtained by using a posture model, such as by applying the posture model to the motion data. In some embodiments, the output of the posture model is used to determine whether the user took the correct posture, pose, etc., when performing one or more aspects of the practice. In such embodiments, a practice may have a set order of postures, poses, etc., and it may be determined whether the user incorrectly or correctly performed the posture, pose, etc., based on the postures, poses, etc., identified by using the motion data.

In some embodiments, when an aspect of the practice includes a recitation of one or more words by the user (such as, for example, a prayer or chant), audio data of the user may be recorded while the user performs the practice, such as via a microphone. In such embodiments, when the user takes a posture or position that indicates that they are performing an aspect of the practice that includes recitation of the one or more words the audio data may be recorded and associated with the aspect of the practice. The audio data may be compared to stored audio data or text data indicating the correct recitation for the aspect of the practice to determine whether the recitation by the user was incorrect.

In some embodiments, where the practice has a set order of postures, poses, etc., one or more previous postures, poses, etc., taken by the user may be recorded. In some embodiments, the progress of the user in performing the practice may be tracked based on the recorded postures, poses, etc. In some embodiments, the previously recorded postures, poses, etc., are used to determine whether a user has incorrectly performed an aspect of the practice. In some embodiments, the amount of time spent by the user during one or more aspects of the practice is used to determine whether a user incorrectly performed an aspect of the practice.

If it is determined that the user incorrectly performed an aspect of the practice, the process 500 proceeds to act 504, otherwise the process 500 ends. At act 504, the incorrect performance of the aspect of the practice is indicated to the user. In some embodiments, indicating that the performance of the aspect of the practice is incorrect includes displaying a message to a user via a device, such as a user computing device, a wearable computing device, a display of a conductive floor mat, another device, or some combination thereof. In some embodiments, indicating that the performance of the aspect of the practice is incorrect includes utilizing haptic feedback, such as a vibration. In such embodiments, the haptic feedback may be provided by the conductive floor mat, a user computing device, a wearable computing device, another device, or a combination thereof. In some embodiments, indicating that the performance of the aspect of the practice is incorrect includes causing an audible sound or message to be played, such as via an audio system of a conductive floor mat, user computing device, wearable computing device, other device, or some combination thereof. In some embodiments, the indication that the performance of the aspect of the practice is incorrect occurs during the performance of the practice, after the practice, or some combination thereof. In some embodiments, the indication that the performance of the aspect of the practice is incorrect includes instructions regarding how to correctly perform the aspect of the practice.

After act 504, the process 500 ends. In some embodiments, the process 500 is performed while the user is performing the practice. In such embodiments, the user may receive feedback regarding an incorrectly performed aspect of the practice while the user is performing the practice.

In some embodiments, an application executed by a user computing device receives data regarding the performance of the practice by a user, such as the data described above in connection with FIGS. 3, 4, and 5. In such embodiments, the application may be used to share the data with user computing devices associated with other users. In some such embodiments, the application may be used to allow users to compete with each other regarding the performance of the practice.

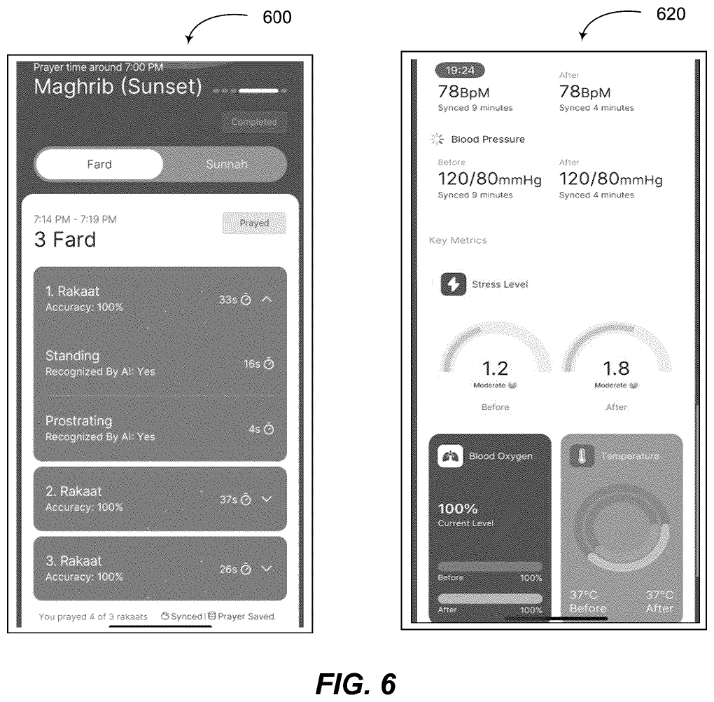

FIG. 6 display diagram of sample screens presented via a display after a user's performance of a practice, according to various embodiments described herein. The sample screen 600 is a first sample screen that may be presented to a user after performing their practice in some embodiments. The sample screen 600 includes an indication of one or more aspects of the practice performed by the user. For example, the sample screen 600 indicates that the user performed 3 “Rakaat” for the Maghrib Islamic prayer, that the positions for each of the Rakaat were recognized by a machine learning model, and the amount of time that the user spent each of the positions and each of the Rakaat.

The sample screen 620 includes information indicating the physiological state of the user before and after the performance of the practice. In some embodiments, the sample screen 620 includes information indicating the physiological state of the user during the performance of the practice. The sample screen 620 may include an indication of a heart rate, heart rate variability (HRV), respiratory rate, blood pressure, galvanic skin response (sweat), body temperature, brain waves (EEG), blood oxygen saturation (SpO2), other physiological data, or some combination thereof. In some embodiments, one or more of the screens 600 and 620 indicate whether the user has achieved a state of heart-brain coherence.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system comprising:
a conductive floor mat, the conductive floor mat being grounded;
one or more sensors configured to sense environmental data regarding the environment surrounding the conductive floor mat; and
a computing device in communication with the one or more sensors, the computing device being configured to:
receive environmental data from the one or more sensors;
generate an evaluation of the environment around the conductive floor mat based on the environmental data; and
indicate the evaluation of the environment via a display.

2. The system of claim 1, wherein the conductive floor mat includes one or more of:
carbon fiber;
copper;
silver;
conductive carbon leather;
conductive polyurethane leather;
fibers; and
rubber.

3. The system of claim 1, wherein the one or more sensors comprise one or more of:
a magnetometer;
an electromagnetic field sensor;
a photonic sensor unit; and
a conductivity sensor.

4. The system of claim 1, wherein the computing device is further configured to:
apply a machine learning model to the environmental data to obtain the evaluation of the environment, the machine learning model being configured to generate an evaluation of an environment based on environmental data.

5. The system of claim 1, wherein the one or more sensors comprise a photonic sensor unit and at least one other sensor, wherein:
the photonic sensor unit is caused to open a shutter of the photonic sensor unit for a selected period of time; and
the at least one other sensor is caused to sense data regarding the environment surrounding the conductive floor mat while the shutter of the photonic sensor unit is open.

6. The system of claim 5, wherein to receive the environmental data from the one or more sensors, the computing device is further caused to:
cause at least one of the one or more sensors to obtain initial background condition data before the shutter of the photonic sensor unit is opened.

7. The system of claim 6, wherein the initial background condition data comprises at least one of:
electromagnetic field data; and
geomagnetic field data.

8. The system of claim 1, wherein the conductive floor mat is a prayer mat having one or more sensors selectively positioned to detect a posture of an Islamic prayer.

9. The system of claim 1, wherein the system further comprises a wearable device configured to detect one or more of:
a prayer;
a recitation; and
a chant.

10. One or more instances of non-transitory computer-readable media collectively having contents configured to cause a computing device to perform a method comprising:
receiving an indication of a practice performed by a user;
in response to receiving the indication of the practice performed by the user, receiving sensor data from one or more sensors, the sensor data indicating a physiological state of the user;
receiving environmental data regarding the environment in which the practice is performed by the user;
identifying one or more changes in the physiological state of the user as a result of performing the practice based on the sensor data; and
determining whether the environment in which the practice is performed affected the physiological state of the user based on the one or more changes in the physiological state of the user, the environmental data, and historical data indicating the physiological state of the user when performing the practice.

11. The one or more instances of non-transitory computer-readable media of claim 10, wherein the one or more sensors include at least one of:
a gyroscope;
a microphone;
an accelerometer;
a heart rate sensor;
a blood pressure sensor;
a compass;
a barometer; and
a global-positioning system (GPS).

12. The one or more instances of non-transitory computer-readable media of claim 10, wherein receiving the indication of a practice performed by the user further comprises:
receiving second sensor data from the one or more sensors; and
determining whether the user has begun performing the practice based on the sensor data.

13. The one or more instances of non-transitory computer-readable media of claim 12, wherein determining whether the user has begun performing the practice further comprises:
identifying one or more positions by applying a machine learning model to the second sensor data, the machine learning model being configured to identify one or more positions of the user based on sensor data; and
determining whether the user has begun performing the practice based on the one or more positions.

14. The one or more instances of non-transitory computer-readable media of claim 10, wherein the method further comprises:
applying a machine learning model to the sensor data, the machine learning model being configured to identify one or more positions of the user based on sensor data;
receiving an indication of one or more positions of a user when performing the practice;
determining whether the user performed at least one aspect of the practice incorrectly based on the identified one or more positions and the indication of one or more positions of a user when performing the practice; and
based on a determination that the user performed at least one aspect of the practice incorrectly, indicating that the user performed at least one aspect of the practice incorrectly.

15. The one or more instances of non-transitory computer-readable media of claim 10, wherein receiving the environmental data further comprises:
receiving environmental data from one or more environmental sensors of a conductive floor mat, the one or more environmental sensors being configured to sense environmental data regarding the environment surrounding the conductive floor mat.

16. A system comprising:
a conductive floor mat, the conductive floor mat being grounded;
a first set of sensors configured to sense environmental data regarding the environment surrounding the conductive floor mat;
a second set of sensors configured to sense physiological data of a user; and
at least one computing device in communication with the first set of sensors, the at least one computing device being configured to:
receive environmental data from the one or more sensors;
generate an evaluation of the environment around the conductive floor mat based on the environmental data;
indicate the evaluation of the environment via a display;
receive an indication of a practice performed by a user;
in response to receiving the indication of the practice performed by the user, receiving physiological data from the second set of sensors;
identify one or more changes in the physiological state of the user as a result of performing the practice based on the physiological data;
determine whether the environment in which the practice is performed affected the physiological state of the user based on the one or more changes in the physiological state of the user, the environmental data, and historical data indicating the physiological state of the user when performing the practice; and
indicate to the user whether the environment in which the practice is performed affected the physiological state of the user.

17. The system of claim 16, wherein the first set of sensors comprise one or more of:
a magnetometer;
an electromagnetic field sensor;
a photonic sensor unit; and
a grounding sensor.

18. The system of claim 16, wherein the second set of sensors comprise one or more of:
a gyroscope;
a microphone;
an accelerometer;
a heart rate sensor;
a blood pressure sensor;
a compass;
a barometer; and
a global-positioning system (GPS).

19. The system of claim 16, wherein at least one sensor of the second set of sensors is a wearable sensor.
